(19) United States
(12) Patent Application Publication
(10) Pub. No.: US 2025/0016820 A1
(43) Pub. Date: Jan. 9, 2025

(54) Low Latency Data Preemption

(71) Applicant: Apple Inc., Cupertino, CA (US)

(72) Inventors: Zhou Lan, San Jose, CA (US); Chittabrata Ghosh, Fremont, CA (US); Anuj Batra, Redwood City, CA (US); Wook Bong Lee, San Jose, CA (US); Mohamed Abouelseoud, Burlingame, CA (US); Morteza Mehrnoush, Hayward, CA (US)

(21) Appl. No.: 18/763,735

(22) Filed: Jul. 3, 2024

Related U.S. Application Data
(60) Provisional application No. 63/512,511, filed on Jul. 7, 2023.

(51) Int. Cl. H04W 72/566; H04L 5/00; H04W 84/12

(52) U.S. Cl. CPC H04W 72/566; H04L 5/0055; H04W 84/12

(57) ABSTRACT

Systems, methods, and mechanisms for preemption of non-low latency data within an aggregated medium access control (MAC) protocol data unit (AMPDU), e.g., such as in current and future IEEE 802.11 systems. A wireless device (e.g., an access point or wireless station) may transmit, during an AMPDU, a trigger to receive (TRX) frame. The TRX frame may indicate preemption of non-low latency data intended for a first wireless station with low latency data intended for a second wireless station, e.g., via an acknowledgement policy change. Additionally, the wireless device may be configured to transmit, to the second wireless station, the low latency data within the AMPDU. Further, the wireless device may be configured to receive, after the AMPDU transmission is complete, a multi-block acknowledgement (M-BA) frame from the second wireless station. The M-BA frame and completion of the AMPDU transmission are separated by a short inter-frame space (SIFS).

### PRIORITY INFORMATION

This application claims priority to U.S. Provisional Patent Application No. 63/512,511, entitled “Low Latency Data Preemption,” filed Jul. 7, 2023, which is hereby incorporated by reference in its entirety as though fully and completely set forth herein.

### FIELD

The present application relates to wireless communications, including techniques for preemption of non-low latency data within an aggregated medium access control (MAC) protocol data unit (AMPDU), e.g., such as in current and future IEEE 802.11 systems.

### DESCRIPTION OF THE RELATED ART

In current implementations, multiple medium access control (MAC) service data units (MSDUs) can be aggregated together to form an aggregated MSDU (AMSDU) and each AMSDU may serve as a MAC protocol data unit (MPDU). Then, multiple MPDUs may be aggregated to form an aggregated MPDU (AMPDU). Thus, an AMPDU includes multiple frames of data while reducing transmission overhead. However, there may be some inherent downsides to multiple aggregations. For example, a transmitter may wait to send a particular frame until it has collected enough frames to aggregate, causing a delay in the transmission of the particular frame. Further, once the AMPDU has been transmitted, the transmitter needs to wait for completion of the transmission before attempting another transmission. However, this may be an issue when low latency (e.g., delay sensitive) data arrives at the transmitter. Delay of low latency data can be undesirable. Therefore, improvements are desired.

### SUMMARY

Embodiments described herein relate to systems, methods, and mechanisms for preemption of non-low latency data within an aggregated medium access control (MAC) protocol data unit (AMPDU), e.g., such as in current and future IEEE 802.11 systems.

For example, in some embodiments, a wireless device, such as an access point or wireless station, may be configured to transmit, during an AMPDU, a trigger to receive (TRX) frame. The TRX frame may indicate preemption of non-low latency data intended for a first wireless station with low latency data intended for a second wireless station, e.g., via an acknowledgement policy change. Additionally, the wireless device may be configured to transmit, to the second wireless station, the low latency data within the AMPDU. Further, the wireless device may be configured to receive, after the AMPDU transmission is complete, a multi-block acknowledgement (M-BA) frame from the second wireless station. The M-BA frame and completion of the AMPDU transmission are separated by a short inter-frame space (SIFS).

As another example, in some embodiments, a wireless station may be configured to receive, from a wireless device during an AMPDU, a TRX frame. The TRX frame may indicate preemption of non-low latency data intended for a first wireless station with low latency data, e.g., via an acknowledgement policy change. Additionally, the wireless station may be configured to receive, from the wireless device, the low latency data within the AMPDU. Further, the wireless station may be configured to transmit, after the AMPDU transmission is complete, an M-BA frame to the wireless device. The M-BA frame and completion of the AMPDU transmission are separated by a SIFS.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example of a wireless communication system, according to some embodiments.

FIG. 2A illustrates an example of wireless devices communicating, according to some embodiments.

FIG. 2B illustrates an example simplified block diagram of a wireless device, according to some embodiments.

FIG. 2C illustrates an example WLAN communication system, according to some embodiments.

FIG. 3A illustrates an example simplified block diagram of a WLAN Access Point (AP), according to some embodiments.

FIG. 3B illustrates an example simplified block diagram of a wireless station (UE), according to some embodiments.

FIG. 3C illustrates an example simplified block diagram of a wireless node, according to some embodiments.

FIGS. 4A and 4B illustrate examples of using a TRX frame within an AMPDU to indicate possible preemption and/or preemption of non-low latency data with low latency data, according to some embodiments.

FIG. 5A illustrates an example of a transmitter continuing to transmit non-low latency data post preemption, according to some embodiments.

FIG. 5B illustrates an example of a transmitter padding an AMPDU post preemption, according to some embodiments.

FIG. 5C illustrates an example of a transmitter transmitting additional low-latency data to another wireless station post preemption, according to some embodiments.

FIG. 6 illustrates an example of a transmitter transmitting a physical reference signal during an AMPDU, according to some embodiments.

FIG. 7 illustrates an example of a transmitter transmitting an AMPDU delimiter to indicate a preemption of non-low latency data with low latency data, according to some embodiments.

FIG. 8 illustrates an example of a transmitter transmitting a MU-BAR frame to indicate a preemption of non-low latency data with low latency data, according to some embodiments.

FIG. 9 illustrates a block diagram of an example of a method for preemption of non-low latency data, according to some embodiments.

FIG. 10 illustrates a block diagram of an example of a method for preemption of non-low latency data, in some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:
UE: User Equipment
AP: Access Point
TX: Transmission/Transmit
RX: Reception/Receive
UWB: Ultra-wideband
BT/BLE: BLUETOOTH™/BLUETOOTH™ Low Energy
LAN: Local Area Network
WLAN: Wireless LAN
RAT: Radio Access Technology

### Terminology

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium-a memory medium as described above, as well as a physical transmission medium, such as a bus, network, and/or other physical transmission medium that conveys signals such as electrical, electromagnetic, or digital signals.

Computer System-any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Positional Tag (or tracking device)—any of various types of computer systems devices which are mobile or portable and which performs wireless communications, such as communication with a neighboring or companion device to share, determine, and/or update a location of the positional tag. Wireless communication can be via various protocols, including, but not limited to, Bluetooth, Bluetooth Low Energy (BLE), Wi-Fi, ultra-wide band (UWB), and/or one or more proprietary communication protocols.

Mobile Device (or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using WLAN or Wi-Fi.

Wireless Device (or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element-refers to various implementations of digital circuitry that perform a function in a computer system. Additionally, processing element may refer to various implementations of analog or mixed-signal (combination of analog and digital) circuitry that perform a function (or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically-refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent-refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

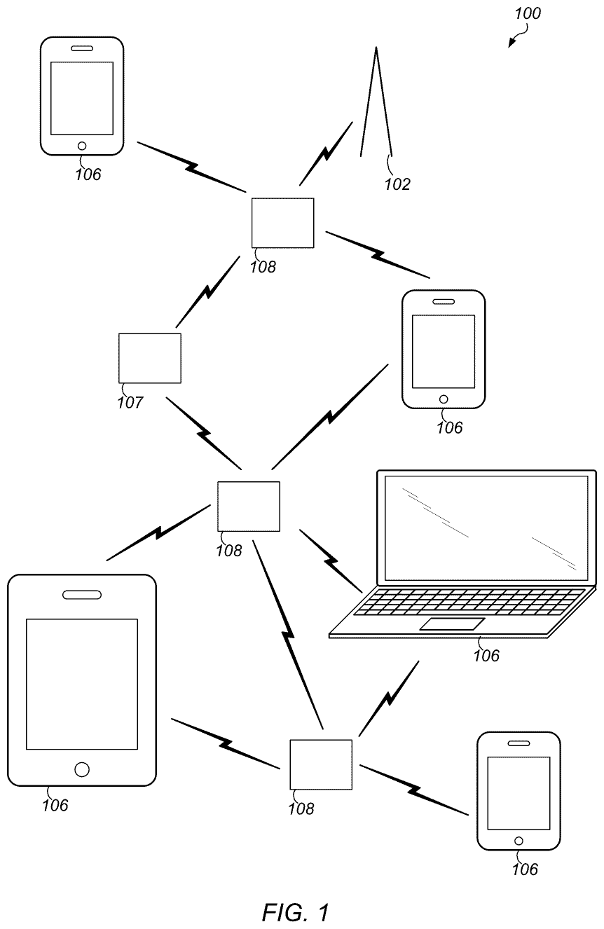

### FIG. 1—Wireless Communication System

FIG. 1 illustrates an example wireless communication system, according to some embodiments. It is noted that the system of FIG. 1 is merely one example of a possible system, and embodiments of this disclosure may be implemented in any of various systems, as desired. As shown, the exemplary system 100 includes a plurality of wireless client stations or devices, or user equipment (UEs), 106 that are configured to communicate wirelessly with various components within the system 100, such as an Access Point (AP) 112, other client stations 106, wireless nodes 107, and/or positional tag devices 108. Some implementations can include one or more base stations in addition to, or in place of, AP 112. The AP 112 may be a Wi-Fi access point and may include one or more other radios/access technologies (e.g., Bluetooth (BT), ultra-wide band (UWB), etc.) for wirelessly communicating with the various components of system 100. The AP 112 may communicate via wired and/or wireless communication channels with one or more other electronic devices (not shown) and/or another network, such as the Internet. The AP 112 may be configured to operate according to any of various communications standards, such as the various IEEE 802.11 standards as well as one or more proprietary communication standards, e.g., based on wideband, ultra-wideband, and/or additional short range/low power wireless communication technologies. In some embodiments, at least one client station 106 may be configured to communicate directly with one or more neighboring devices (e.g., other client stations 106, wireless nodes 107, and/or positional tag devices 108), without use of the access point 112 (e.g., peer-to-peer (P2P) or device-to-device (D2D)). As shown, wireless node 107 may be implemented as any of a variety of devices, such as wearable devices, gaming devices, and so forth. In some embodiments, wireless node 107 may be various Internet of Things (IoT) devices, such as smart appliances (e.g., refrigerator, stove, oven, dish washer, clothes washer, clothes dryer, and so forth), smart thermostats, and/or other home automation devices (e.g., such as smart electrical outlets, smart lighting fixtures, and so forth).

As shown, a positional tag device 108 may communicate with one or more other components within system 100. In some embodiments, positional tag device 108 may be associated with a companion device (e.g., a client station 106) and additionally be capable of communicating with one or more additional devices (e.g., other client stations 106, wireless nodes 107, AP 112). In some embodiments, communication with the companion device may be via one or more access technologies/protocols, such as BLUETOOTH™ (and/or BLUETOOTH™ (BT) Low Energy (BLE)), Wi-Fi peer-to-peer (e.g., Wi-Fi Direct, Neighbor Awareness Networking (NAN), and so forth), millimeter wave (mmWave) (e.g., 60 GHz, such as 802.11 ad/ay), as well as any of various proprietary protocols (e.g., via wideband or ultra-wideband (UWB) and/or low and/or ultra-low power (LP/ULP) wireless communication). In some embodiments, communication with additional devices may be via BT/BLE as well as one or more other short-range peer-to-peer wireless communication techniques (e.g., various near-field communication (NFC) techniques, RFID, NAN, Wi-Fi Direct, UWB, LT/ULP, and so forth). In some embodiments, positional tag device 108 may be capable of updating a server with a current location (e.g., determined by tag device 108 and/or provided to tag device 108 from another device) via the one or more additional devices as well as via the companion device.

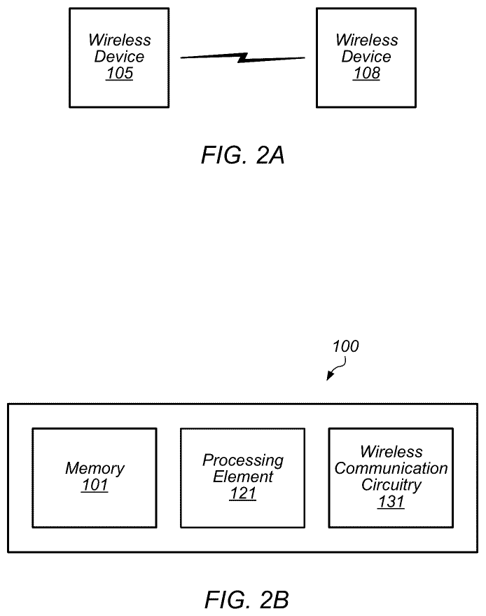

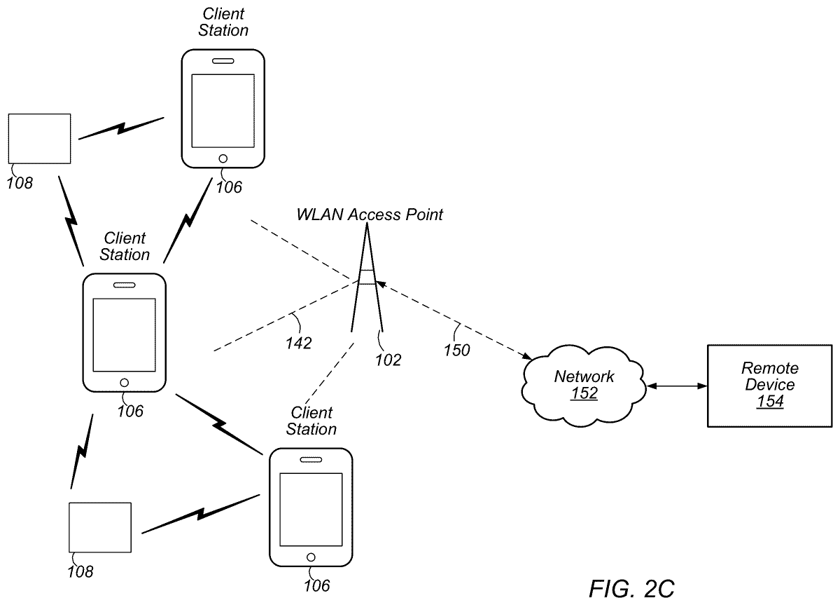

### FIGS. 2A-2B-Wireless Communication System

FIG. 2A illustrates an exemplary (and simplified) wireless communication system in which aspects of this disclosure may be implemented. It is noted that the system of FIG. 2A is merely one example of a possible system, and embodiments of this disclosure may be implemented in any of various systems, as desired.

As shown, the exemplary wireless communication system includes a (“first”) wireless device 105 in communication with another (“second”) wireless device 108. The first wireless device 105 and the second wireless device 108 may communicate wirelessly using any of a variety of wireless communication techniques.

As one possibility, the first wireless device 105 and the second wireless device 108 may perform communication using wireless local area networking (WLAN) communication technology (e.g., IEEE 802.11/Wi-Fi based communication) and/or techniques based on WLAN wireless communication. One or both of the wireless device 105 and the wireless device 108 may also (or alternatively) be capable of communicating via one or more additional wireless communication protocols, such as any of BLUETOOTH™ (BT), BLUETOOTH™ Low Energy (BLE), near field communication (NFC), RFID, UWB, LP/ULP, LTE, LTE-Advanced (LTE-A), 5G NR, etc.

The wireless devices 105 and 108 may be any of a variety of types of wireless device. As one possibility, wireless device 105 may be a substantially portable wireless user equipment (UE) device, such as a smart phone, hand-held device, a laptop computer, a wearable device (such as a smart watch), a tablet, a motor vehicle, or virtually any type of wireless device. As another possibility, wireless device 105 may be a substantially stationary device, such as a payment kiosk/payment device, point of sale (POS) terminal, set top box, media player (e.g., an audio or audiovisual device), gaming console, desktop computer, appliance, door, access point, base station, or any of a variety of other types of device. The wireless device 108 may be a positional tag device, e.g., in a stand-alone form factor, associated with, attached to, and/or otherwise integrated into another computing device, and/or associated with, attached to, and/or integrated into a personal article or device (e.g., a wallet, a backpack, luggage, a briefcase, a purse, a key ring/chain, personal identification, and so forth) and/or a commercial article (e.g., a shipping container, shipping/storage pallet, an item of inventory, a vehicle, and so forth).

Each of the wireless devices 105 and 108 may include wireless communication circuitry configured to facilitate the performance of wireless communication, which may include various digital and/or analog radio frequency (RF) components, one or more processors configured to execute program instructions stored in memory, one or more programmable hardware elements such as a field-programmable gate array (FPGA), a programmable logic device (PLD), an application specific IC (ASIC), and/or any of various other components. The wireless device 105 and/or the wireless device 108 may perform any of the method embodiments or operations described herein, or any portion of any of the method embodiments or operations described herein, using any or all of such components.

Each of the wireless devices 105 and 108 may include one or more antennas and corresponding radio frequency front-end circuitry for communicating using one or more wireless communication protocols. In some cases, one or more parts of a receive and/or transmit chain may be shared between multiple wireless communication standards; for example, a device might be configured to communicate using BT/BLE or Wi-Fi using partially or entirely shared wireless communication circuitry (e.g., using a shared radio or one or more shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components that are shared between multiple wireless communication protocols, and one or more radios or radio components that are used exclusively by a single wireless communication protocol. For example, a device might include a shared radio for communicating using one or more of LTE, and/or 5G NR, and one or more separate radios for communicating using Wi-Fi and/or BT/BLE. Other configurations are also possible.

As previously noted, aspects of this disclosure may be implemented in conjunction with the wireless communication system of FIG. 2A. For example, a wireless device (e.g., either of wireless devices 105 or 108) may be configured to implement (and/or assist in implementation of) the methods described herein.

FIG. 2B illustrates an exemplary wireless device 110 (e.g., corresponding to wireless devices 105 and/or 108) that may be configured for use in conjunction with various aspects of the present disclosure. The device 110 may be any of a variety of types of device and may be configured to perform any of a variety of types of functionality. The device 110 may be a substantially portable device or may be a substantially stationary device, potentially including any of a variety of types of device. The device 110 may be configured to perform any of the techniques or features illustrated and/or described herein, including with respect to any or all of the Figures.

As shown, the device 110 may include a processing element 121. The processing element may include or be coupled to one or more memory elements. For example, the device 110 may include one or more memory media (e.g., memory 111), which may include any of a variety of types of memory and may serve any of a variety of functions. For example, memory 111 could be RAM serving as a system memory for processing element 121. Additionally or alternatively, memory 111 could be ROM serving as a configuration memory for device 110. Other types and functions of memory are also possible.

Additionally, the device 110 may include wireless communication circuitry 131. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 131 may include its own processing element(s) (e.g., a baseband processor), e.g., in addition to the processing element 121. For example, the processing element 121 may be an ‘application processor’ whose primary function may be to support application layer operations in the device 110, while the wireless communication circuitry 131 may be a ‘baseband processor’ whose primary function may be to support baseband layer operations (e.g., to facilitate wireless communication between the device 110 and other devices) in the device 110. In other words, in some cases the device 110 may include multiple processing elements (e.g., may be a multi-processor device). Other configurations (e.g., instead of or in addition to an application processor/baseband processor configuration) utilizing a multi-processor architecture are also possible. In some implementations, baseband functionality can be performed using any of a variety of combinations of processor(s), instructions, software, and/or circuitry, instead of in (or in addition to) a dedicated baseband processor.

The device 110 may additionally include any of a variety of other components (not shown) for implementing device functionality, depending on the intended functionality of the device 110, which may include further processing and/or memory elements (e.g., audio processing circuitry), one or more power supply elements (which may rely on battery power and/or an external power source) user interface elements (e.g., display, speaker, microphone, camera, keyboard, mouse, touchscreen, etc.), and/or any of various other components.

The components of the device 110, such as processing element 121, memory 111, and wireless communication circuitry 131, may be operatively (or communicatively) coupled via one or more interconnection interfaces, which may include any of a variety of types of interface, possibly including a combination of multiple types of interfaces. As one example, a USB high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 121, peripheral interfaces for communication with peripheral components within or external to device 110, etc.) may also be provided as part of device 110.

### FIG. 2C-WLAN System

FIG. 2C illustrates an example WLAN system according to some embodiments. As shown, the exemplary WLAN system includes a plurality of wireless client stations or devices, or user equipment (UEs), 106 that are configured to communicate over a wireless communication channel 142 with an Access Point (AP) 112. In some embodiments, the AP 112 may be a Wi-Fi access point. The AP 112 may communicate via wired and/or wireless communication channel(s) 150 with one or more other electronic devices (not shown) and/or another network 152, such as the Internet. Additional electronic devices, such as the remote device 154, may communicate with components of the WLAN system via the network 152. For example, the remote device 154 may be another wireless client station. The WLAN system may be configured to operate according to any of various communications standards, such as the various IEEE 802.11 standards. In some embodiments, at least one wireless device 106 is configured to communicate directly with one or more neighboring mobile devices, such as positional tag devices 108, without use of the access point 112.

Further, in some embodiments, as further described below, a wireless device 106 (which may be an exemplary implementation of device 110) may be configured to perform (and/or assist in performance of) the methods described herein.

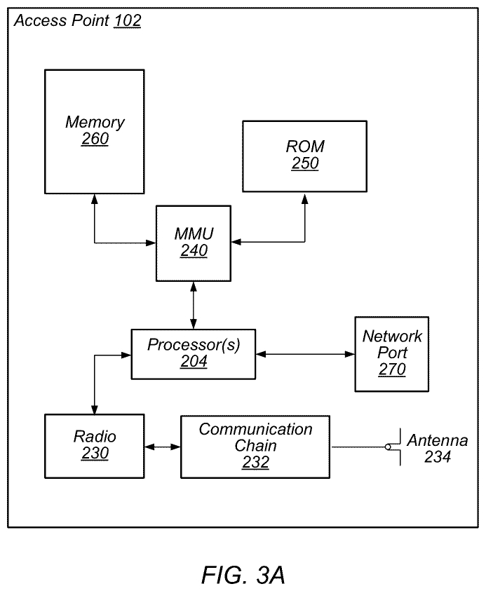

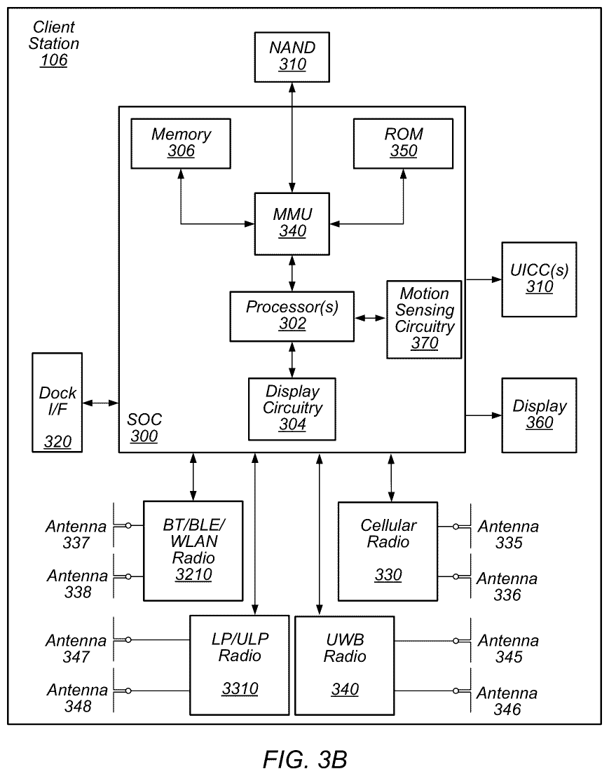

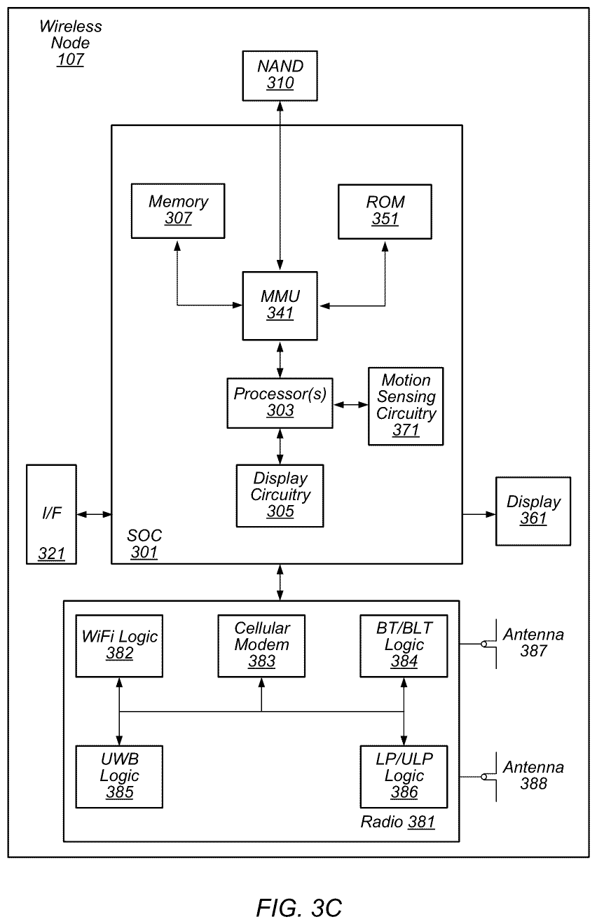

### FIG. 3A-Access Point Block Diagram

FIG. 3A illustrates an exemplary block diagram of an access point (AP) 112, which may be one possible exemplary implementation of the device 110 illustrated in FIG. 2B. It is noted that the block diagram of the AP of FIG. 3A is only one example of a possible system. As shown, the AP 112 may include processor(s) 204, which may execute program instructions for the AP 112. The processor(s) 204 may also be coupled (directly or indirectly) to memory management unit (MMU) 240, which may be configured to receive addresses from the processor(s) 204 and to translate those addresses into locations in memory (e.g., memory 260 and read only memory (ROM) 250) or to other circuits or devices.

The AP 112 may include at least one network port 270. The network port 270 may be configured to couple to a wired network and provide a plurality of devices, such as mobile devices 106, access to the Internet. For example, the network port 270 (or an additional network port) may be configured to couple to a local network, such as a home network or an enterprise network. For example, port 270 may be an Ethernet port. The local network may provide connectivity to one or more additional networks, such as the Internet.

The AP 112 may include at least one antenna 234 and wireless communication circuitry 230, which may be configured to operate as a wireless transceiver and may be further configured to communicate with mobile device 106 (as well as positional tag device 108). The antenna 234 communicates with the wireless communication circuitry 230 via communication chain 232. Communication chain 232 may include one or more receive chains and/or one or more transmit chains. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, BT/BLE, UWB, and/or LP/ULP. Further, in some embodiments, the wireless communication circuitry 230 may also, or alternatively, be configured to communicate via various other wireless communication technologies, including, but not limited to, Fifth Generation (5G) New Radio (NR), Long-Term Evolution (LTE), LTE Advanced (LTE-A), Wideband Code Division Multiple Access (WCDMA), etc., for example when the AP is co-located with a base station in case of a small cell, or in other instances when it may be desirable for the AP 112 to communicate via various different wireless communication technologies.

Further, in some embodiments, as further described below, AP 112 may be configured to perform (and/or assist in performance of) the methods described herein.

### FIG. 3B-Client Station Block Diagram

FIG. 3B illustrates an example simplified block diagram of a client station 106, which may be one possible exemplary implementation of the device 110 illustrated in FIG. 2B. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, etc., short to medium range wireless communication circuitry 329 (e.g., Bluetooth™ and WLAN circuitry), low power/ultra-low power (LP/ULP) radio 339, and ultra-wideband radio 341. The client station 106 may further include one or more smart cards 310 that incorporate SIM (Subscriber Identity Module) functionality, such as one or more UICC(s) (Universal Integrated Circuit Card(s)) cards 345. The cellular communication circuitry 330 may couple to one or more antennas, such as antennas 335 and 336 as shown. The short to medium range wireless communication circuitry 329 may also couple to one or more antennas, such as antennas 337 and 338 as shown. LP/ULP radio 339 may couple to one or more antennas, such as antennas 347 and 348 as shown. Additionally, UWB radio 341 may couple to one or more antennas, such as antennas 345 and 346. Alternatively, the radios may share one or more antennas in addition to, or instead of, coupling to respective antennas or respective sets of antennas. Any or all of the radios may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The SOC 300 may also include motion sensing circuitry 370, which may detect motion of the client station 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses into locations in memory (e.g., memory 306, read only memory (ROM) 350, NAND flash memory 310) and/or to other circuits or devices, such as the display circuitry 304, cellular communication circuitry 330, short range wireless communication circuitry 329, LP/ULP communication circuitry 339, UWB communication circuitry 341, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations and/or one or more positional tag devices 108. The client station 106 may be configured to communicate according to a WLAN RAT for communication in a WLAN network, such as that shown in FIG. 2C. Further, in some embodiments, as further described below, client station 106 may be configured to perform (and/or assist in performance of) the methods described herein.

As described herein, the client station 106 may include hardware and/or software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 329, 330, 335, 336, 337, 338, 339, 340, 341, 345, 346, 347, 348, 350, and/or 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 204.

Further, as described herein, cellular communication circuitry 330 and short-range wireless communication circuitry 329 may each include one or more processing elements. Thus, each of cellular communication circuitry 330 and short-range wireless communication circuitry 329 may include one or more integrated circuits (ICs) configured to perform the functions of cellular communication circuitry 330 and short-range wireless communication circuitry 329, respectively.

### FIG. 3C-Wireless Node Block Diagram

FIG. 3C illustrates one possible block diagram of a wireless node 107, which may be one possible exemplary implementation of the device 110 illustrated in FIG. 2B. As shown, the wireless node 107 may include a system on chip (SOC) 301, which may include portions for various purposes. For example, as shown, the SOC 301 may include processor(s) 303 which may execute program instructions for the wireless node 107, and display circuitry 305 which may perform graphics processing and provide display signals to the display 361. The SOC 301 may also include motion sensing circuitry 371 which may detect motion of the wireless node 107, for example using a gyroscope, accelerometer, and/or any of various other motion sensing components. The processor(s) 303 may also be coupled to memory management unit (MMU) 341, which may be configured to receive addresses from the processor(s) 303 and translate those addresses to locations in memory (e.g., memory 307, read only memory (ROM) 351, flash memory 311). The MMU 341 may be configured to perform memory protection and page table translation or set up. In some embodiments, the MMU 341 may be included as a portion of the processor(s) 303.

As shown, the SOC 301 may be coupled to various other circuits of the wireless node 107. For example, the wireless node 107 may include various types of memory (e.g., including NAND flash 311), a connector interface 321 (e.g., for coupling to a computer system, dock, charging station, etc.), the display 361, and wireless communication circuitry (radio) 381 (e.g., for 5G NR, LTE, LTE-A, Bluetooth, Wi-Fi, NFC, GPS, UWB, LP/ULP, etc.).

The wireless node 107 may include at least one antenna, and in some embodiments, multiple antennas 387 and 388, for performing wireless communication with base stations and/or other devices. For example, the wireless node 107 may use antennas 387 and 388 to perform the wireless communication. As noted above, the wireless node 107 may in some embodiments be configured to communicate wirelessly using a plurality of wireless communication standards or radio access technologies (RATs).

The wireless communication circuitry (radio) 381 may include Wi-Fi Logic 382, a Cellular Modem 383, BT/BLE Logic 384, UWB logic 385, and LP/ULP logic 386. The Wi-Fi Logic 382 is for enabling the wireless node 107 to perform Wi-Fi communications, e.g., on an 802.11 network and/or via peer-to-peer communications (e.g., NAN). The BT/BLE Logic 384 is for enabling the wireless node 107 to perform Bluetooth communications. The cellular modem 383 may be capable of performing cellular communication according to one or more cellular communication technologies. The UWB logic 385 is for enabling the wireless node 107 to perform UWB communications. The LP/ULP logic 386 is for enabling the wireless node 107 to perform LP/ULP communications. Some or all components of the wireless communication circuitry 381 may be used for communications with a positional tag device 108.

As described herein, wireless node 107 may include hardware and software components for implementing embodiments of this disclosure. For example, one or more components of the wireless communication circuitry 381 of the wireless node 107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). For example, in some embodiments, as further described below, wireless node 107 may be configured to perform (and/or assist in the performance of) the methods described herein.

### Data Preemption

In current implementations, multiple MSDUs can be aggregated together to form an aggregated MSDU (AMSDU) and each AMSDU may serve as a MAC protocol data unit (MPDU). Further, multiple MPDUs may be aggregated together to form an aggregated MPDU (AMPDU). Thus, an AMPDU that includes multiple frames of data can be transmitted with lower overhead than transmitting individual MSDUs or individual MPDUs. However, there may be some inherent downsides to multiple aggregations. For example, a transmitter may wait to send a particular frame until it has collected enough frames to aggregate, causing a delay in the transmission of the particular frame. Further, once the AMPDU has been transmitted, the transmitter needs to wait for completion of the transmission before attempting another transmission. However, this may be an issue when low latency (e.g., delay sensitive) data arrives at the transmitter. Delay of low latency data can be undesirable. Therefore, improvements are desired.

Embodiments described herein relate to systems, methods, and mechanisms for preemption of non-low latency data within an aggregated medium access control (MAC) protocol data unit (AMPDU), e.g., such as in current and future IEEE 802.11 systems. For example, in some embodiments described herein, preemption of non-low latency data within an AMPDU may be indicated via a trigger to receive (TRX) frame included in the AMPDU. The TRX frame may change an acknowledgement policy from implicit block acknowledgment (BA) to immediate acknowledgment for low latency MPDUs. As another example, in some embodiments described herein, preemption of non-low latency data within an AMPDU may be indicated via an AMPDU delimiter in combination with a TRX frame, e.g., within a Physical Layer Convergence Procedure (PLCP) service data unit (PSDU). As a further example, in some embodiments, described herein, preemption of non-low latency data within an AMPDU may be indicated via insertion of a multi-user (MU) block acknowledgement request (BAR) frame (MU-BAR frame) within the AMPDU.

For example, in some instances, an AMPDU structure may be preserved and preemption of non-low latency data may be indicated via a trigger to receive (TRX) frame included in the AMPDU. The preemption may preempt a corresponding resource unit (RU) allocation. In some instances, multiple TRX frames may be inserted into an AMPDU to indicate/reserve potential preemption locations (e.g., timing of a preemption). As an example, TRX frames may be inserted into an AMPDU structure after every N bytes and/or every N milliseconds, where N is predefined and/or indicated by a transmitting device (e.g., such as an access point 112 and/or a wireless station 106 operating as an access point). Thus, neighboring devices can time wake-up/monitoring intervals to coincide with TRX frames in the AMPDU. In some instances, to indicate preemption, a TRX frame may switch an acknowledgement policy from no immediate acknowledgement (ACK) to immediate ACK. In addition, the TRX frame may include an indication of which stations have data to receive. Further, in such a scheme, low latency MPDUs may use an implicit block ACK (BA) policy in which low latency MPDUs are immediately acknowledged and non-low latency MPDUs may use a standard BA policy in which non-low latency MPDUs are acknowledged via a BA after completion of the AMPDU.

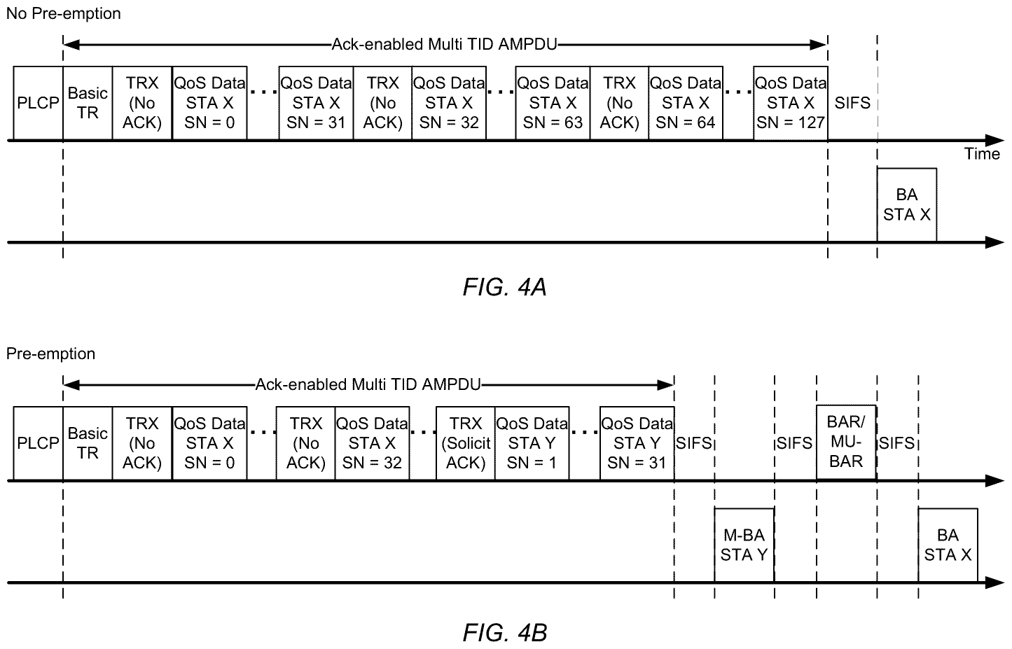

FIGS. 4A and 4B illustrate examples of using a TRX frame within an AMPDU to indicate possible preemption (e.g., FIG. 4A) and preemption (e.g., FIG. 4B) of non-low latency data with low latency data, according to some embodiments. For example, as shown in FIGS. 4A and 4B, a physical layer convergence protocol (PLCP) header frame may precede a start of an AMPDU. The AMPDU may then being with a basic trigger response (TR) frame followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame.

As shown in FIG. 4A, after the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. Further, at the subsequent TRX frame, wireless station X as well as other wireless stations may monitor/receive the TRX frame. Based on the contents of the TRX frame, wireless station X may determine that the transmitter has additional data for wireless station X. Thus, wireless station X may continue to receive data as shown. At the conclusion of the AMPDU and after a short inter-frame space (SIFS), wireless X may transmit a block ACK (BA), as shown.

As shown in FIG. 4B, after the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. Further, at the subsequent TRX frame, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. At the conclusion of the AMPDU and after a SIFS, wireless station Y may transmit a multi-BA. Further, after another SIFS, the transmitter may transmit a BA request (BAR) and/or a multi-BAR (MU-BAR) frame. In response and after a SIFS, wireless station X may transmit a BA, e.g., responsive to the BAR/MU-BAR frame.

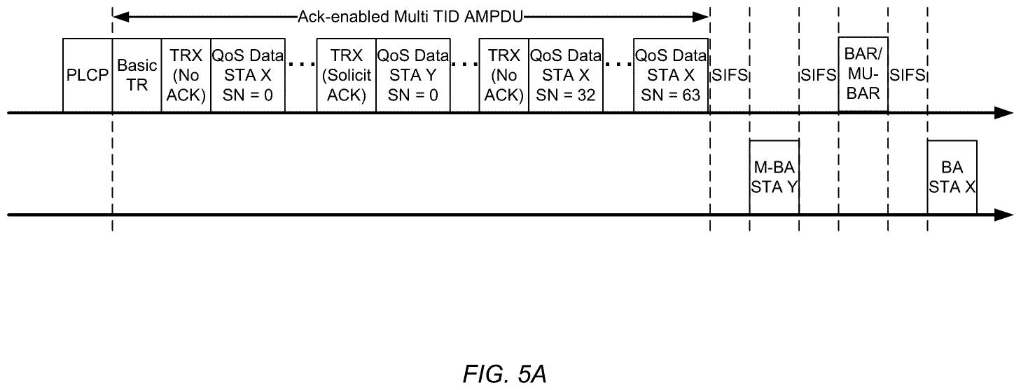

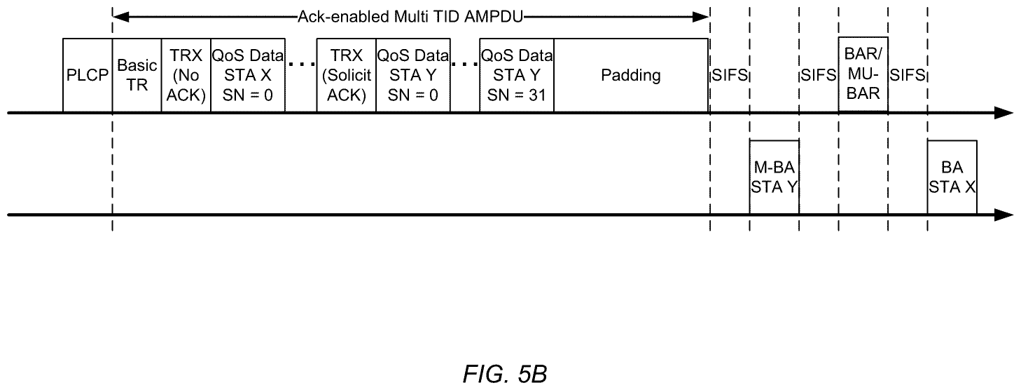

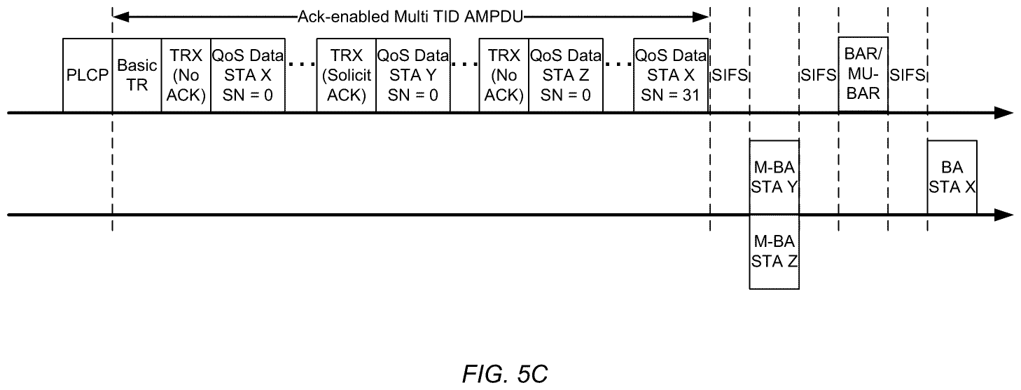

In some instances, after preemption, a transmitter may continue to transmit non-low latency data to wireless station in the AMPDU, transmit low latency data to another wireless station, and/or add padding to complete the AMPDU. For example, FIGS. 5A, 5B, and 5C illustrate these various instances.

Turning to FIG. 5A, illustrated is an example of a transmitter continuing to transmit non-low latency data post preemption, according to some embodiments. As shown, a physical layer convergence protocol (PLCP) header frame may precede a start of an AMPDU. The AMPDU may then being with a basic trigger response (TR) frame followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame. After the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. Further, at the subsequent TRX frame, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. After completion of the transmission to wireless station Y, the transmitter may transmit another TRX frame. Additionally, based on contents of the TRX frame, wireless station X may determine that the transmitter intends to transmit additional data to wireless station X. In addition, the TRX frame may indicate an action of no ACK (e.g., switch ACK policy from immediate ACK/soliciting ACK to no immediate ACK). Thus, after the TRX frame, data transmission to wireless station X may resume with a next sequence frame number. At the conclusion of the AMPDU and after a SIFS, wireless station Y may transmit a multi-BA. Further, after another SIFS, the transmitter may transmit a BA request (BAR) and/or a multi-BAR (MU-BAR) frame. In response and after a SIFS, wireless station X may transmit a BA, e.g., responsive to the BAR/MU-BAR frame.

Turning to FIG. 5B, illustrated is an example of a transmitter padding an AMPDU post preemption, according to some embodiments. As shown, a physical layer convergence protocol (PLCP) header frame may precede a start of an AMPDU. The AMPDU may then being with a basic trigger response (TR) frame followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame. After the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. Further, at the subsequent TRX frame, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. After completion of the transmission to wireless station Y, the transmitter may use MAC end of frame (EOF) padding to complete the AMPDU. At the conclusion of the AMPDU and after a SIFS, wireless station Y may transmit a multi-BA. Further, after another SIFS, the transmitter may transmit a BA request (BAR) and/or a multi-BAR (MU-BAR) frame. In response and after a SIFS, wireless station X may transmit a BA, e.g., responsive to the BAR/MU-BAR frame.

Turning to FIG. 5C, illustrated is an example of a transmitter transmitting additional low-latency data to another wireless station post preemption, according to some embodiments. As shown, a physical layer convergence protocol (PLCP) header frame may precede a start of an AMPDU. The AMPDU may then being with a basic trigger response (TR) frame followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame. After the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. Further, at the subsequent TRX frame, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. After completion of the transmission to wireless station Y, the transmitter may transmit another TRX frame. Additionally, based on contents of the TRX frame, a wireless station Z may determine that the transmitter intends to transmit low-latency data to wireless station Z. In addition, the TRX frame may indicate an action of immediate ACK/soliciting ACK. Thus, after the TRX frame, data transmission to wireless station Z may start. At the conclusion of the AMPDU and after a SIFS, wireless stations Y and Z may transmit a multi-BA. Further, after another SIFS, the transmitter may transmit a BA request (BAR) and/or a multi-BAR (MU-BAR) frame. In response and after a SIFS, wireless station X may transmit a BA, e.g., responsive to the BAR/MU-BAR frame.

Note that in the above instances, a basic TR frame and a TRX frame may have/indicate the same receiving address and MPDUs (e.g., data) that follows the TRX frame may also have the same receiving address. Thus, a TRX frame intended for wireless station X may have a first receiving address and subsequent MPDUs for wireless station X may have the first receiving address. Similarly, a TRX frame intended for wireless statin Y may have a second receiving address and subsequent MPDUs for wireless station Y may have the second receiving address. In addition, in some instances, the basic TR frame may include resource unit indications for both wireless station X and wireless station Y for BA transmission. In other instances, an alternative resource unit may be indicated for wireless station X that wireless station X may use for BA transmission when pre-empted.

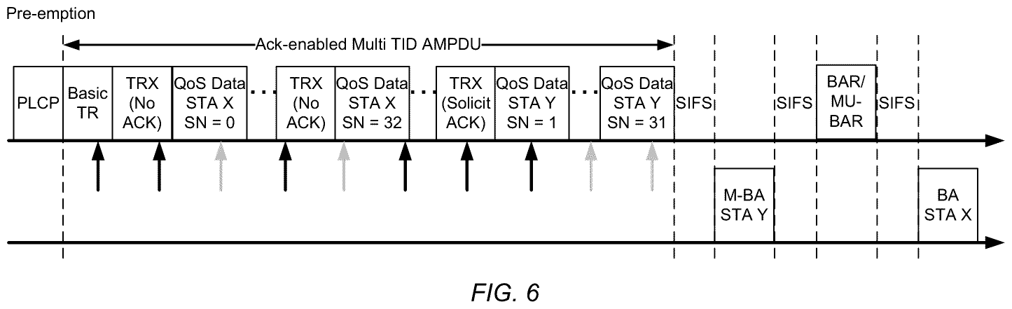

In some instances, e.g., as illustrated by FIG. 6, a transmitter (e.g., such as access point 112 and/or a wireless station 106) may transmit a reference signal (e.g., midamble) in a PPDU. The reference signal may be periodic. Further, wireless stations may wakeup to receive a closest reference signal prior to a next TRX frame, e.g., to reacquire timing and synchronization in order to receive the next TRX frame. Thus, as shown, a physical reference signal (e.g., midamble) may be periodically transmitted during an AMPDU. The physical reference signal may be received by wireless stations waking just prior to a TRX frame (e.g., darker arrows indicate received physical reference signals).

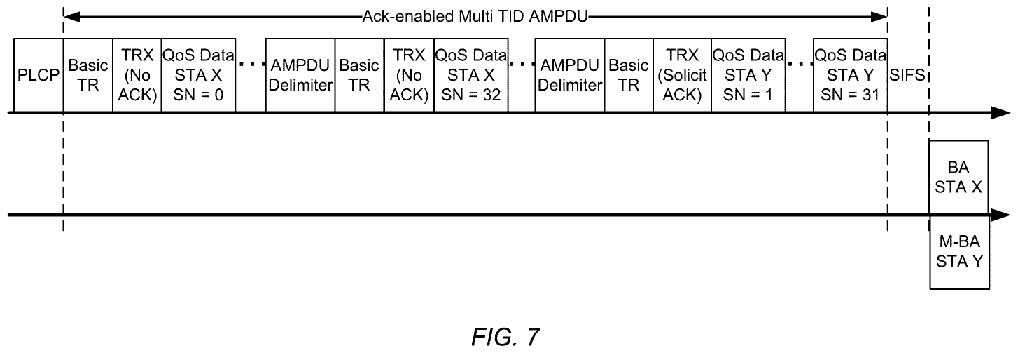

In some instances, e.g., as illustrated by FIG. 7, an AMPDU delimiter may be introduced in an AMPDU to indicate a preemption of non-low latency data with low latency data. Thus, as shown, a physical layer convergence protocol (PLCP) header frame may precede a start of an AMPDU. The AMPDU may then being with a basic trigger response (TR) frame followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame. After the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. After completion of data transmission to wireless station X, an AMPDU delimiter frame may be transmitted in the AMPDU, e.g., to delineate and/or make a boundary withing the AMPDU. After the AMPDU delimiter, the transmitter may transmit another basic TR frame followed by a TRX frame. Thus, wireless station X as well as other wireless stations may monitor/receive the TRX frame. Based on the contents of the TRX frame, wireless station X may determine that the transmitter has additional data for wireless station X. Thus, wireless station X may continue to receive data as shown. At the conclusion of the AMPDU and after a short inter-frame space (SIFS), wireless X may transmit a block ACK (BA), as shown. After completion of data transmission to wireless station X, an AMPDU delimiter frame may be transmitted in the AMPDU, e.g., to delineate and/or make a boundary withing the AMPDU. After the AMPDU delimiter, the transmitter may transmit another basic TR frame followed by a TRX frame. Thus, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. At the conclusion of the AMPDU and after a SIFS, wireless station Y may transmit a multi-BA. Further, after another SIFS, the transmitter may transmit a BA request (BAR) and/or a multi-BAR (MU-BAR) frame. In response and after a SIFS, wireless station X may transmit a BA, e.g., responsive to the BAR/MU-BAR frame.

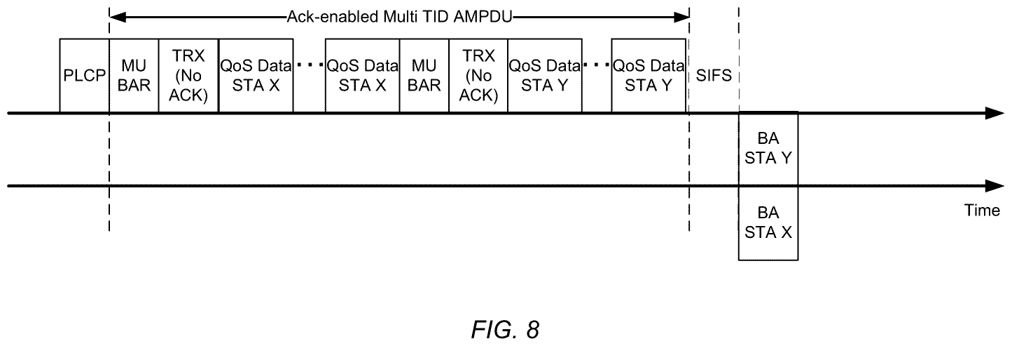

In some instances, e.g., as illustrated by FIG. 8, a MU-BAR frame may be inserted/added to an AMPDU to indicate a preemption of non-low latency data with low latency data. Thus, as shown, a physical layer convergence protocol (PLCP) header frame may precede a start of an AMPDU. The AMPDU may then being with a MU-BAR frame (and/or another control frame) followed by a TRX frame indicating an action of no AKC (e.g., no immediate ACK is requested). The TRX frame may indicate that a transmitter (e.g., such as an access point 112 and/or a wireless station 106 operating as an access point) has non-low latency for a wireless station X (e.g., STA X). Note that in addition to wireless station X, one or more additional wireless stations, such as a wireless station Y (e.g., STA Y) may monitor/receive the TRX frame. Further, a wireless station that receives the TRX frame may determine, e.g., based on the contents of the TRX frame, whether the transmitter intends to transmit data to the wireless station in the AMPDU. In instances in which the wireless station determines that the transmitter intends to transmit data to the wireless station in a current AMPDU period, the wireless station may remain awake and ready to receive the data. In instances in which the wireless station determines that the transmitter does not intend to transmit data to the wireless station in the current AMPDU period, the wireless station may enter a low power/sleep mode for N milliseconds/bytes and wake up to attend/monitor a subsequent TRX frame. After the TRX frame, wireless station X may receive data (e.g., QoS data) starting with a sequence frame number 0 (e.g., SN=0) to a sequency frame number 31 (e.g., SN=31). During this time period, other wireless stations may be in a low power mode. After completion of data transmission to wireless station X, another MU-BAR frame (and/or another control frame) may be transmitted in the AMPDU, e.g., to indicate possible preemption. After the AMPDU delimiter, the transmitter may transmit another basic TR frame followed by a TRX frame. Thus, wireless station X as well as other wireless stations may monitor/receive the TRX frame. Based on the contents of the TRX frame, wireless station X may determine that the transmitter intends to pre-empt the data transmission with wireless station X due to low latency data being available for transmission to wireless station Y. Thus, wireless station X may enter a sleep state, e.g., at least until a next TRX frame. Further, wireless station Y, which may have woken up for the TRX frame, may determine, e.g., based on the contents of the TRX frame (e.g., such as the TRX frame including an indication of immediate ACK/soliciting ACK), that the transmitter intends to transmit low latency data to wireless station Y. Hence, as shown, after the subsequent TRX frame, wireless station Y may receive data from the transmitter. At the conclusion of the AMPDU and after a SIFS, wireless stations X and transmit a BA.

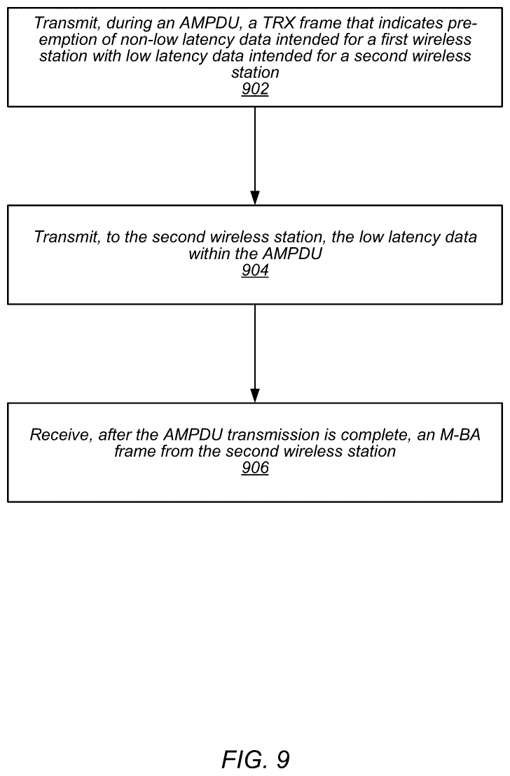

FIG. 9 illustrates a block diagram of an example of a method for preemption of non-low latency data, according to some embodiments. The method shown in FIG. 9 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 902, a transmitter, such as an access point 112 and/or a wireless station 106 operating as an access point, may transmit, during an AMPDU, a trigger to receive (TRX) frame. The TRX frame may indicate preemption of non-low latency data intended for a first wireless station with low latency data intended for a second wireless station. In some instances, the TRX frame may indicate preemption via an acknowledgement policy change. The acknowledgement policy may change to immediate acknowledgement. In some instances, the TRX frame may indicate an acknowledgement solicitation.

At 904, the transmitter may transmit, to the second wireless station, the low latency data within the AMPDU.

At 906, the transmitter may receive, after the AMPDU transmission is complete, a multi-block acknowledgement (M-BA) frame from the second wireless station. In some instances, the M-BA frame and completion of the AMPDU transmission are separated by a short inter-frame space (SIFS).

In some instances, the transmitter may transmit, after receiving the M-BA, a block acknowledgement request (BAR) frame. Further, the transmitter may receive, responsive to the BAR frame, a BA frame from the first wireless station. The M-BA and BAR frame may be separated by a SIFS. Additionally, the BAR frame and BA frame may be separated by a SIFS. In some instances, the BAR frame may be a multi-user BAR (MU-BAR) frame.

In some instances, the transmitter may transmit, prior to the TRX frame, non-low latency data to the first wireless station during the AMPDU.

In some instances, the transmitter may transmit, at a beginning or start of the AMPDU, a basic trigger (TR) frame. The basic TR frame may indicate a resource unit for the M-BA frame. The basic TR frame may include a first receiving address associated with the first wireless station and a second receiving address associated with the second wireless station. In addition, the TRX frame may include an indication of the second receiving address.

In some instances, the transmitter may periodically transmit a physical reference signal in a physical protocol data unit (PPDU). The physical reference signal may provide synchronization for the first wireless station and the second wireless station. The physical reference signal may be a midamble.

In some instances, the transmitter may transmit, after transmission of the low latency data to the second wireless station, an other TRX frame. The other TRX frame may indicate there is non-low latency data intended for the first wireless station. Additionally, the transmitter may transmit, to the first wireless station, the non-low latency data within the AMPDU. Further, the TRX frame may indicate an acknowledgement policy change from immediate acknowledgement.

In some instances, the transmitter may transmit, after transmission of the low latency data to the second wireless station, end of frame (EOF) padding to fill a remainder of the AMPDU.

In some instances, the transmitter may transmit, after transmitting the low latency data to the second wireless station, an additional TRX frame, wherein the additional TRX frame indicates preemption of non-low latency data intended for the first wireless station with low latency data intended for a third wireless station. Additionally, the transmitter may transmit, to the third wireless station, the low latency data within the AMPDU and receive, after the AMPDU transmission is complete, an M-BA frame from the third wireless station.

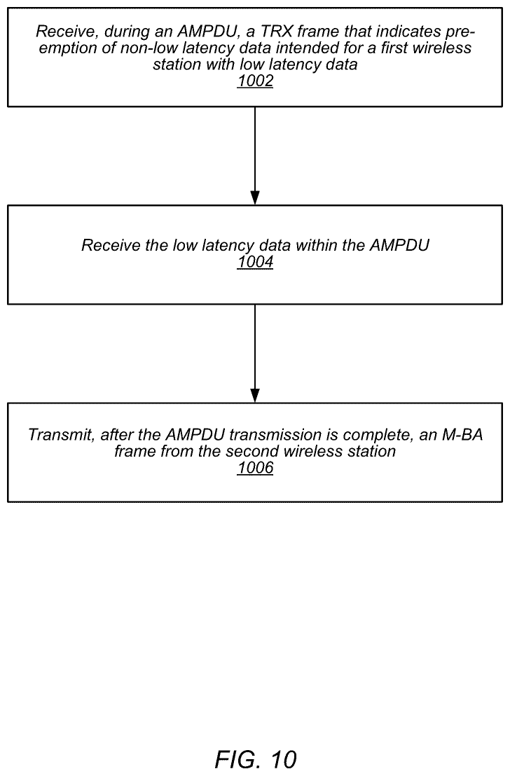

FIG. 10 illustrates a block diagram of an example of a method for preemption of non-low latency data, in some embodiments. The method shown in FIG. 10 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1002, a wireless station, such as wireless station 106, may receive, during an AMPDU, a trigger to receive (TRX) frame from a wireless device (e.g., an access point, such as access point 112, and/or a wireless station operating as an access point, such as wireless station 106). The TRX frame may indicate preemption of non-low latency data intended for a first wireless station with low latency data. In some instances, the TRX frame may indicate preemption via an acknowledgement policy change. The acknowledgement policy may change to immediate acknowledgement. The TRX frame may indicate an acknowledgement solicitation.

At 1004, the wireless station may receive, from the wireless device, the low latency data within the AMPDU.

At 1006, the wireless station may transmit, to the wireless device, after the AMPDU transmission is complete, a multi-block acknowledgement (M-BA) frame from the second wireless station. In some instances, the M-BA frame and completion of the AMPDU transmission may be separated by a SIFS.

In some instances, the wireless station may receive, at a beginning or start the AMPDU, a basic trigger (TR) frame. The basic TR frame may indicate a resource unit for the M-BA frame. In some instances, the basic TR frame may include a first receiving address associated with the first wireless station and a second receiving address. Further, the TRX frame may include an indication of the second receiving address.

In some instances, the wireless station may periodically receive, from the wireless device, a physical reference signal in a physical protocol data unit (PPDU). The physical reference signal may provide synchronization for the first wireless station and the second wireless station. The physical reference signal may be a midamble. In some instances, the wireless station may wake up, prior to the TRX frame, to receive the physical reference signal. The timing of the wake up may be based, at least in part, on timing of the physical reference signal relative to the TRX frame. Further, the wireless station may synchronize timing with the wireless device prior to receiving the TRX frame.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device may be configured to include a processor (or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for preemption of non-low latency data, comprising:
transmitting, during an aggregated medium access control (MAC) protocol data unit (AMPDU), a trigger to receive (TRX) frame that indicates preemption of non-low latency data intended for a first wireless station, wherein the preemption allows for communication of low latency data intended for a second wireless station;
transmitting, to the second wireless station, the low latency data within the AMPDU; and
receiving, after the AMPDU transmission, a multi-block acknowledgement (M-BA) frame from the second wireless station.

2. The method of claim 1,
wherein the TRX frame preemptionuses an acknowledgement policy change to indicate the preemption.

3. The method of claim 2,
wherein the acknowledgement policy change indicates a switch to immediate acknowledgement.

4. The method of claim 1,
wherein the TRX frame indicates an acknowledgement solicitation.

5. The method claim 1,
wherein the M-BA frame and an end of the AMPDU transmission are separated by a short inter-frame space (SIFS).

6. The method of any claim 1, further comprising:
transmitting, after receiving the M-BA, a block acknowledgement request (BAR) frame; and
receiving, responsive to the BAR frame, a block acknowledgment (BA) frame from the first wireless station.

7. The method of claim 6,
wherein the M-BA and the BAR frame are separated by a short inter-frame space (SIFS); and
wherein the BAR frame and the BA frame are separated by a SIFS.

8. The method of claim 6,
wherein the BAR frame comprises a multi-user BAR (MU-BAR) frame.

9. An apparatus, comprising:
a memory; and
at least one processor in communication with the memory and configured to cause a wireless station to perform operations including:
transmitting, during an aggregated medium access control (MAC) protocol data unit (AMPDU), a trigger to receive (TRX) frame indicating preemption of non-low latency data intended for a first wireless station, wherein the preemption allows for communication of low latency data intended for a second wireless station;
transmitting, to the second wireless station, the low latency data within the AMPDU; and
receiving, after the AMPDU transmission, a multi-block acknowledgement (M-BA) frame from the second wireless station.

10. The apparatus of claim 9,
wherein the at least one processor is further configured to cause the wireless station to perform operations including:
transmitting, prior to the TRX frame, non-low latency data to the first wireless station during the AMPDU.

11. The apparatus of claim 9,
wherein the at least one processor is further configured to cause the wireless station to perform operations including:
transmitting, at a start of the AMPDU, a basic trigger (TR) frame, wherein the basic TR frame indicates a resource unit for the M-BA frame.

12. The apparatus of claim 11,
wherein the basic TR frame includes a first receiving address associated with the first wireless station and a second receiving address associated with the second wireless station.

13. The apparatus of claim 12,
wherein the TRX frame includes an indication of the second receiving address.

14. The method of claim 1, further comprising:
periodically transmitting a physical reference signal in a physical protocol data unit (PPDU), wherein the physical reference signal provides synchronization for the first wireless station and the second wireless station.

15. The apparatus of claim 14,
wherein the physical reference signal comprises a midamble.

16. A non-transitory computer readable memory medium storing program instructions that, when executed, cause a device to:
transmit, during an aggregated medium access control (MAC) protocol data unit (AMPDU), a trigger to receive (TRX) frame that indicates preemption of non-low latency data intended for a first wireless station, wherein the preemption allows for communication of low latency data intended for a second wireless station;
transmit, to the second wireless station, the low latency data within the AMPDU; and
receive, after the AMPDU transmission, a multi-block acknowledgement (M-BA) frame from the second wireless station.

17. The non-transitory computer readable memory medium of claim 16,
wherein the program instructions are further executable to cause the device to:
transmit, after transmission of the low latency data to the second wireless station, an other TRX frame, wherein the other TRX frame indicates that there is non-low latency data intended for the first wireless station; and
transmit, to the first wireless station, the non-low latency data within the AMPDU.

18. The non-transitory computer readable memory medium of claim 17,
wherein the TRX frame indicates a change from an acknowledgement policy of immediate acknowledgement.

19. The non-transitory computer readable memory medium of claim 16,
wherein the program instructions are further executable to cause the device to:
transmit, after transmission of the low latency data to the second wireless station, end of frame (EOF) padding to fill a remainder of the AMPDU.

20. The non-transitory computer readable memory medium of claim 16,
wherein the program instructions are further executable to cause the device to:
transmit, after transmitting the low latency data to the second wireless station, an additional TRX frame, wherein the additional TRX frame indicates preemption of non-low latency data intended for the first wireless station with low latency data intended for a third wireless station;
transmit, to the third wireless station, the low latency data within the AMPDU; and
receive, after the AMPDU transmission is complete, an M-BA frame from the third wireless station.
